(19) United States
(12) Patent Application Publication
(10) Pub. No.: US 2017/0371113 A1
(43) Pub. Date: Dec. 28, 2017

(54) OPTICAL AXIS ALIGNMENT METHOD, OPTICAL AXIS ALIGNMENT APPARATUS AND METHOD FOR MANUFACTURING OPTICAL DEVICE

(71) Applicant: MITSUBISHI ELECTRIC CORPORATION, Chiyoda-ku, Tokyo (JP)

(72) Inventors: Masaya SHIMONO, Chiyoda-ku, Tokyo (JP); Hidekazu KODERA, Chiyoda-ku, Tokyo (JP); Daisuke MORITA, Chiyoda-ku, Tokyo (JP)

(73) Assignee: MITSUBISHI ELECTRIC CORPORATION, Chiyoda-ku, Tokyo (JP)

(21) Appl. No.: 15/523,114

(22) PCT Filed: Jan. 15, 2016
(86) PCT No.: PCT/JP2016/051155

§ 371 Date: Apr. 28, 2017

(30) Foreign Application Priority Data
Jan. 21, 2015 (JP) 2015-009324

(51) Int. Cl. G02B 6/42; G02B 7/00; G02B 6/32; G02B 7/02

(52) U.S. Cl. CPC G02B 6/4226; G02B 7/023; G02B 7/003; G02B 6/32; G02B 6/4215; G02B 6/4206; G02B 6/4237

(57) ABSTRACT

An optical axis alignment method may include the steps of taking an image of a lens holder and a holder base to obtain contour information before laser irradiation, detecting location information about a light path of a light beam which exits from a collimating lens, adjusting the position of the collimating lens by plastically deforming via laser irradiation, taking an image of a contour of a lens holder and a base member to obtain new contour information and detecting new location information about a light path of a light beam which exits from the collimating lens. If the accuracy is not within the predetermined allowable limits, the laser irradiation condition is corrected based on the contour information and/or the location information obtained both before and after the laser irradiation and the lens position adjustment is repeated.

### TECHNICAL FIELD

The present invention relates to an optical axis alignment method and an optical axis alignment apparatus and a method for manufacturing an optical device.

### BACKGROUND ART

Recently, communication traffic volume in an optical network has gotten increased. Hence, a light communication module with a smaller size is required that has a higher communication capacity and needs less electric power consumption. Patent Document 1, for example, discloses a light communication module including four laser light sources each emitting light of different wavelength and a single optical multiplexer, the laser light sources and the optical multiplexer being connected via four lens, thereby accomplishing a high communication capacity and a small size. In the conventional light communication module the four laser light sources requires to be mounted so that they each have a high coupling efficiency and they have a small variation in a coupling efficiency among the four. In this case, the four laser light sources and the optical multiplexer should be assembled with a high accuracy.

A method for assembling an integrated optical module is discussed below where a plurality of laser light sources are optically coupled by a single optical multiplexer, with reference to conventional prior arts.

Patent Document 1 discloses a method including performing alignment by displacing a lens while detecting a light from a laser light source and fixing the lens via soldering or YAG laser welding. This method including displacing the lens while detecting a light from a laser light source to fix it, which enables tolerances of elements and misaligned positions occurred in one or more previous processes to be compensated, consequently resulting in a high optical coupling efficiency. This method in turn occurs a new problem that an optical coupling efficiency is decreased due to a misaligned position of the lens possibly occurred when the lens is fixed. Optical coupling between the plurality of laser light sources and the single optical multiplexer increases the extent to which the position of the lens is misaligned, which leads to a variation in optical coupling efficiencies among the laser light sources.

Patent Document 2 discloses a method including applying an external force against a lens holder after fixing a lens to plastically deform the lens holder, correcting the position where the lens is fixed for improving an optical coupling efficiency. However, a light communication module having a demanded smaller size and a demanded high integration density possibly occurs an interruption between a tool for applying the external force and a neighbor lens holder, which makes the alignment difficult. Further, when the step of correcting is manually performed, time required to complete the step is elongated.

Patent Documents 3 and 4 each disclose an optical axis alignment method via laser irradiation for occurring melt-solidification of an irradiated portion to shrink it. This method enables a laser irradiation for a cylinder shaped housing accommodating a single light emitter from every direction to conduct a fine alignment. Arranging a plurality of light emitters and a plurality of lens on the same substrate enables the substrate, the emitters and an optical multiplexer to be mounted with an improved accuracy. However, arranging a plurality of lens holder on the same substrate makes it difficult to conduct an alignment via laser irradiation from every direction.

Patent Document 5 discloses a method including plastically deforming a lens holder and correcting a position to which the lens is fixed, by means of YAG laser without direct contact with the lens holder. In the method, YAG laser irradiation is performed from limited range of directions. This enables, when a plurality of lens are mounted in a single light communication module, to correct the position of each of the lens.

### PRIOR ART DOCUMENTS

### Patent Documents

Patent Document 1: US 2011/0013869 A

Patent Document 2: JP H2-308209 A

Patent Document 3: JP 2005-43479 A

Patent Document 4: JP 2005-214776 A

Patent Document 5: JP 2013-231937 A

### SUMMARY OF INVENTION

### Problems to be Solved by the Invention

When a plurality of lenses are mounted in an integrated light communication module with an accuracy of sub micrometer order, positional misalignment occurred when the lens are fixed is concerned. Such a misalignment can be compensated by an additional correction of the lens position after it is fixed, which enables the lens to be mounted with an accuracy of sub micrometer order.

However, additional correction process of the lens position occurs longer time required to complete an optical axis alignment, which decreases productivity.

It is an object of the present invention to provide an optical axis alignment method and an optical axis alignment apparatus with a higher accuracy and less time required for the alignment, and a method for manufacturing the optical device.

### Means for Solving the Problems

In order to solve the above problem, an optical axis alignment method for an optical device according to the present invention, where the device includes a lens having an optical axis, a holder for holding the lens and a base member to which the holder is fixed, comprises the steps of:
detecting a first location information about a light path of a light beam which exits from the lens;
taking an image of a contour of the holder and the base member to obtain a first contour information;
by irradiating with laser light at least one of the holder and the base member based on the first location information and the first contour information to plastically deform them, thereby adjusting a position of the lens within a surface perpendicular to the optical axis to correct an irradiation position or an irradiation dose for a subsequent laser irradiation.

The method of the present invention preferably, further comprises:
detecting a second location information about a light path of a light beam which exits from the lens after adjusting a position of the lens;
taking an image of a contour of the holder and the base member after adjusting a position of the lens to obtain a second contour information;
correcting an irradiation position or an irradiation dose for a subsequent laser irradiation based on the first location information, the second location information, the first contour information and the second contour information.

In the method of the present invention, preferably, the step of correcting an irradiation position or an irradiation dose of includes:
irradiating with laser light an upper surface of the holder holding the lens, when the lens is to be adjusted in a horizontal direction,
irradiating with laser light a position within an upper surface of the holder and on the central axis of the lens, when the lens is to be adjusted downward in a vertical direction, or
irradiating with laser light an upper surface of the base member to which the holder is fixed, when the lens is to be adjusted upward in a vertical direction.

In the method of the present invention, preferably, the step of correcting an irradiation position or an irradiation dose includes irradiating with laser light a position between each of opposite two fixing points where the holder and the base member are fixed to each other and the lens, when the lens is to be adjusted downward in the vertical direction.

In the method of the present invention, preferably, the optical device is a light communication module, the module including:
one or more light sources;
a collimating lens provided as said lens for establishing an optical coupling with the light source;
an optical multiplexer for establishing an optical coupling with the collimating lens;
a substrate on which the light source, the base member and the optical multiplexer is mounted.

An optical axis alignment apparatus for an optical device according to the present invention, where the device includes a lens having an optical axis, a holder for holding the lens and a base member to which the holder is fixed, comprises:
a detector for detecting location information about a light path of a light beam which exits from the lens;
a laser irradiator for irradiating with laser light at least one of the holder and the base member to plastically deform them,
a controller for controlling an irradiation position or an irradiation dose for the laser light based on the location information detected by the detector.
an imager for taking an image of a contour of the holder and the base member to obtain contour information, wherein the controller is configured to correct an irradiation position or an irradiation dose for the laser light based on the contour information obtained by the imager.

In the apparatus of the present invention, preferably, the detector includes a light receiving element and an imaging lens for condensing the light beam which exits from the lens into a receiving surface of the receiving element, the imaging lens having a length of infinity in a light incident side.

A method for manufacturing an optical device according to the present invention comprises the steps of:
preparing a lens having an optical axis;
preparing a holder for holding the lens;
preparing a base member to which the holder is fixed;
assembling the lens, the holder and the base member;
detecting a first location information about a light path of a light which exits beam from the lens;
taking an image of a contour of the holder and the base member to obtain a first contour information;
by irradiating with laser light at least one of the holder and the base member based on the first location information and the first contour information to plastically deform them, thereby adjusting a position of the lens within a surface perpendicular to the optical axis to correct an irradiation position or an irradiation dose for a subsequent laser irradiation.

### Effects of the Invention

According to the present invention, by obtaining two sets of location information about the light path of the light beam both before and after the step of laser irradiation to adjust the position of the lens, the laser irradiation condition can be correlated to the transitional light path of the light beam. This allows the laser irradiation condition to be optimized when the lens position is adjusted, which subsequently enables to perform the optical axis alignment with a higher accuracy and less time required for the alignment.

### BRIEF DESCRIPTION OF DRAWINGS

FIG. 1 shows a light communication module according to an embodiment of the present invention.

FIG. 2 shows a perspective view of an example of a lens holder.

FIG. 3 shows a flow chart illustrating procedures for assembling the light communication module of FIG. 1.

FIG. 4 shows a collimating lens having the position corrected in +Y direction.

FIG. 5 shows the collimating lens having the position corrected in −Y direction.

FIG. 6 shows the collimating lens having the position corrected in −X direction.

FIG. 7 shows a diagram of an optical axis alignment apparatus according to an embodiment of the present invention.

FIG. 8 shows a block diagram illustrating an electrical configuration of the optical axis alignment apparatus according to an embodiment of the present invention.

FIG. 9 shows a diagram of a lens gripper.

FIG. 10 shows s flow chart illustrating an optical axis alignment method according to an embodiment of the present invention.

FIG. 11 shows a perspective view illustrating an example of the lens holder.

FIG. 12 shows the collimating lens having the position corrected in −Y direction.

### DESCRIPTION OF EMBODIMENTS

### First Embodiment

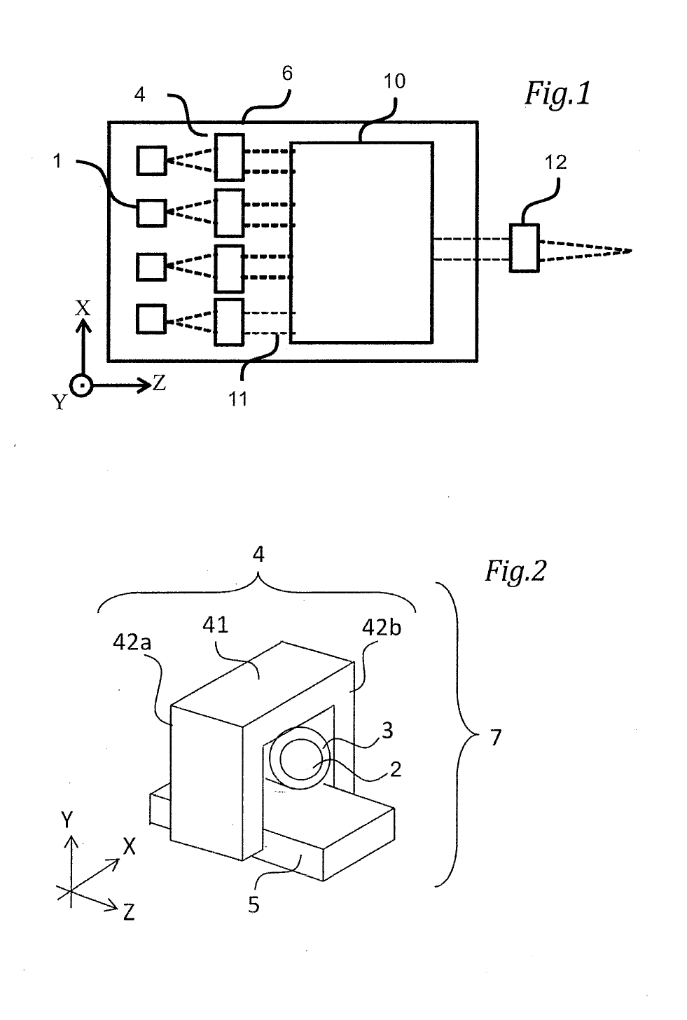

FIG. 1 shows a light communication module or light transmission module according to an embodiment of the present invention. The light communication module is operable to transmit light signals simultaneously each other via a plurality of communication channels such as a wavelength-division multiplexer. In this embodiment, four communication channels are used while two or three channels or more than five channels may be used use in a similar manner.

The light communication module may include four laser light sources 1, four lens holders 4, an optical multiplexer 10 and a carrier substrate 6. In this embodiment, for the purpose of easier understanding, a first direction in which an optical axis of the laser light source 1 extends is referred to as Z direction, a second direction which is perpendicular to the optical axis and parallel to a main surface of the carrier substrate 6 is referred to as X direction, and a third direction which is perpendicular to the optical axis and parallel to the main surface of the carrier substrate 6 is referred to as Y direction.

The laser light sources 1, which may be a semiconductor laser, each emit light having a central wavelength different from each other among the sources 1, the central wavelength being in a range between 1,300 nm and 1,500 nm when wavelength-division multiplexing is employed. The laser light source 1 is adhered on a submount (not shown) via soldering or adhesive bonding and the submount is fixed on the carrier substrate 6 via soldering or adhesive bonding. The laser light source 1 is connected to a circuit such as a drive circuit and/or a modulation circuit, which allows the source 1 to emit light pulse modulated in a high frequency based on a digital signal received from one or more external devices. In FIG. 1, the laser light source 1 is depicted to have the laser emitters, each of which is formed for each of the laser elements. Alternatively, a single laser element may have a plurality of laser emitters formed therein.

The lens holder 4 holds a collimating lens 2, which is configured to convert a laser beam emitted from each of the laser light sources 1 into collimated light ray 11. Laser light in the form of the collimated light rays 11 is ideally collected to one spot on XY plane by means of the optical multiplexer 10 and in turn focused in a spot-like way by the focus lens 12 to be connected to an optical fiber (not shown). Practically, the collimated light rays 11, which are generated after the light beams from the laser light sources 1 are converted by the collimating lens 2, may not coincide to an extent with each other in their locations in XY plane due to tolerances of the laser light sources 1 and the optical multiplexer 10 and due to variations in mounted positions thereof. The extent to which the collimated light rays 11 are not coincident is preferably small such that they are combined to the optical fiber by the condensing lens 12 and they exit from the optical fiber with their light intensity being maintained.

FIG. 2 shows a perspective view of an example of a lens holder. The collimating lens is made of an infrared-transparent material such as glass or silicon. In FIG. 2, the collimating lens 2 is housed in a lens cylinder 3 and held by the lens holder 4. Alternatively, the collimating lens 2 may be directly held by the lens holder 4 without the lens cylinder 3 provided therebetween. The lens cylinder 3 is made of metal and fixed to the lens holder 4.

The lens cylinder 3 may be fixed to the lens holder 4 via soldering, adhesive bonding or YAG laser welding. When the soldering is employed, gold plating is preferably applied on a bonding surface defined between the lens cylinder 3 and the lens holder 4. When the adhesive is applied, gold plating should not be applied. Also, when the YAG laser welding is employed, the lens cylinder 3 and the lens holder 4 are preferably made of a material such as stainless steel or silicon steel plate, which has a high absorbance for YAG laser light having a range of wavelength. Alternatively, either the lens cylinder 3 or the lens holder 4 may be made of a material such as stainless steel or silicon steel plate. When the collimating lens 2 is directly held by the lens holder 4 without the lens cylinder 3 provided therebetween, the YAG laser welding should not be used and the soldering or the adhesive bonding is preferably used.

In this embodiment, the lens cylinder 3 and the lens holder 4 are fixed via the YAG laser welding and they are made of a material having a high absorbance for the YAG laser light.

The lens holder 4 includes a horizontal member 41 extending in X direction and two vertical members 42a, 42b each extending in Y direction from both ends of the horizontal member 41, thereby forming a U shape. The collimating lens 2 is housed in the lens cylinder 3 and fixed to the horizontal member 41 of the lens holder 4 so that the optical axis of the lens 2 is aligned with Z direction. The vertical members 42a, 42b and the holder base 5 working as a base member, to which the members 42a, 42b are fixed, constitute a lens unit 7 as a whole. The lens holder 4 is welded to the holder base 5 to be fixed thereto. Hence, a lower end surface of the lens holder 4 and a lateral surface of the holder base 5 each preferably have a margin for welding.

The lens unit 7 is fixed to the carrier substrate 6. The collimating lens 2 fixed to the lens holder 4 may have a cuboid shape such that the lens 2 conform to the inner shape of the lens holder 4 without the lens cylinder 3 being used. In this example, the lens 2 and the lens holder 4 are fixed to each other via the soldering or the adhesive bonding. The lens unit 7 and the carrier substrate 6 may be fixed to each other via the soldering, the adhesive bonding or the YAG laser welding. When the soldering is employed, gold plating is preferably applied to the bonding surface defined between the carrier substrate 6 and the lens unit 7, i.e. an upper surface of the carrier substrate 6 and the bottom surface of the holder base 5. When the adhesive bonding is employed, the gold plating is not applied. When the YAG laser welding is employed, the holder base 5 and the carrier substrate 6 are preferably made of a material such as stainless steel or silicon steel plate, which has a high absorption for light emitted from the YAG laser. Alternatively, among the two, only the holder base 5 may be made of such a material while the carrier 6 may be made of a material such as copper-tungsten, which has a low absorption for light emitted from the YAG laser.

The optical multiplexer 10 is configured to collect the collimated light rays 11 from the collimating lens 2 into ideally a single position in XY plane at an exit side of the optical multiplexer 10 and to allow the collimated light rays 11 to be consistent in their beam orientations with each other, so that the light rays 11 are incident on the condensing lens 12. As described above, the optical multiplexer 10 may allow a plurality of collimated light rays 11 to be incident on the condensing lens 12 at an identical orientation or align orientations of the collimated light rays 11 incident on the optical multiplexer 10, so that they exit from the optical multiplexer 10 at an identical orientation. In other words, the collimating light rays 11 may be incident on the optical multiplexer 10 at the identical orientation and may be collected to the single position XY plane at the exit side of the optical multiplexer 10 with orientations of the collimating light rays 11 being maintained. Alternatively, the optical multiplexer 10 may be configured to compensate variations in the orientations of the collimated light rays incident on the optical multiplexer 10 and allow the rays 11 to exit with the identical orientation with each other. In this embodiment, the optical multiplexer 10 is configured to allow the collimating light rays 11 incident on the multiplexer 10 to emit it so that the rays 11 are collected to a single position on XY plane with orientations of the rays 11 being maintained.

### (Procedures for Assembling)

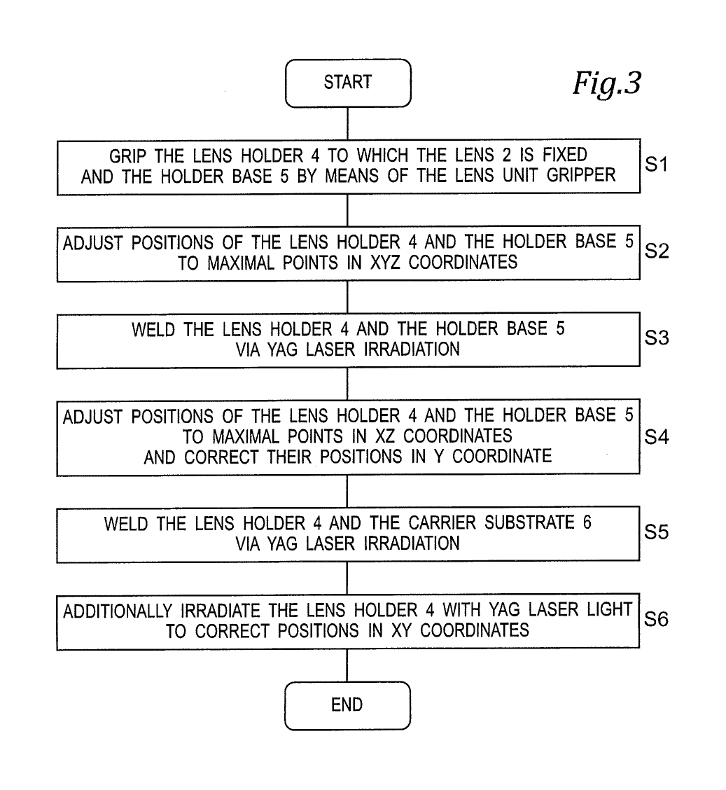

FIG. 3 shows a flow chart illustrating procedures for assembling the light communication module of FIG. 1. In step S1, the lens holder 4 holding the collimating lens 2 and the holder base 5 are gripped by a lens unit gripper.

In step S2, a position of the lens unit 7 is adjusted in X, Y and Z directions with respect to a plurality of laser light sources 1 which are mounted on the carrier substrate 6 to perform an optical axis alignment such that the light emitted from the laser light source 1 is shaped into collimated light rays 11. Orientation of the collimated light rays 11 are preferably adjusted so that the adjusted rays 11 are parallel to a direction around the X-axis of the carrier substrate 6 and are perpendicular to a direction around the Y-axis thereof.

In step S3, the lens holder 4 is fixed to the holder base 5. The lens holder 4 may be fixed to the holder base 5 via soldering, adhesive bonding or YAG laser welding, and in this embodiment, the YAG laser welding is employed. When the soldering or the adhesive bonding is employed, surface treatment such as gold plating should be applied to the bonding surface between the lens holder 4 and the holder base 5 as described above. An optical axis alignment assembling apparatus for performing this assembling process should have a unit for applying the solder or the adhesive and a unit for hardening the bonding materials (e.g. a means for heating or ultra violet irradiation). When the lens holder 4 is fixed to the holder base 5, the adjusted collimating lens 2 is subject to a fine misalignment. Hence, in this process, an extent of the misalignment occurred is preliminarily estimated and an adjustment position is preferably offset based on the extent.

In step S4, the lens unit 7, which is fixed as described above, is subject to the optical axis adjustment again. Because the lens holder 4 and the holder base 5 were already fixed, preventing from adjusting the optical axis in Y direction, the optical axis adjustment is performed only in X and Z directions.

In step S5, the lens unit 7 is fixed on the carrier substrate 6. The lens unit 7 may be fixed on the carrier substrate 6 via the means for fixing the lens holder 4 and the holder base 5 to each other including the soldering, the adhesive bonding and the YAG laser welding as described above, and in this embodiment, the YAG laser welding is employed. In this process, surfaces of the holder base 5 and the carrier substrate 6 are preferably aligned with each other.

Finally, in step S6, the holder base 5 is fixed on the carrier substrate 6 to compensate for a misalignment of the collimating lens 2 occurred when the holder base 5 is fixed. In this step, the lens holder 4 which holds the collimating lens 2 and the holder base 5 are irradiated with YAG laser light for thermal deformation, thereby correcting the position of the collimating lens 2.

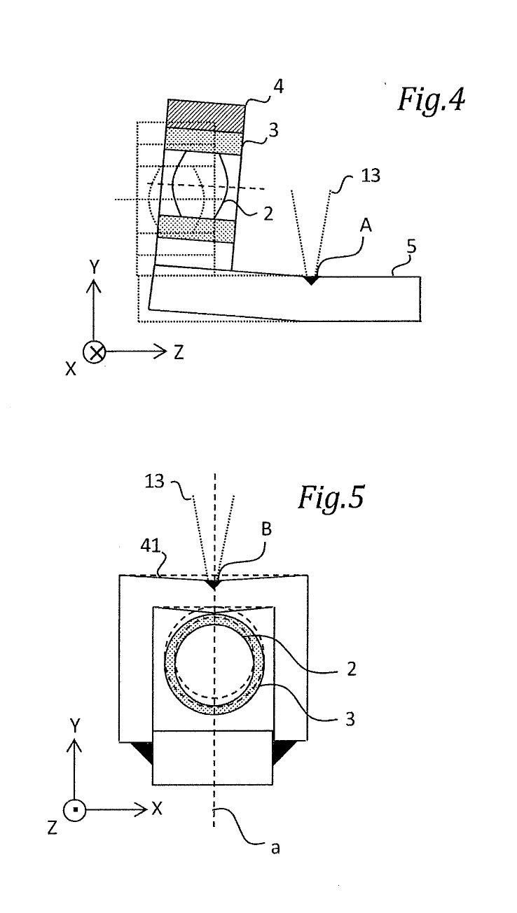

One optical axis adjustment method using laser irradiation is disclosed in Patent Document 5 (JP2013-231937A) and one embodiment thereof is discussed below. When the position of the collimating lens 2 is to be corrected in +Y direction or upward in a vertical direction, a position denoted by A (shown in FIG. 4) defined on the holder base 5 is irradiated with YAG laser light 13. When the position of the collimating lens 2 is corrected in −Y direction or vertically downward, a position denoted by B (shown in FIG. 5) defined on axis (denoted by a as shown in FIG. 5) of the horizontal member 41 of the lens holder 41 is irradiated with the YAG laser light 13.

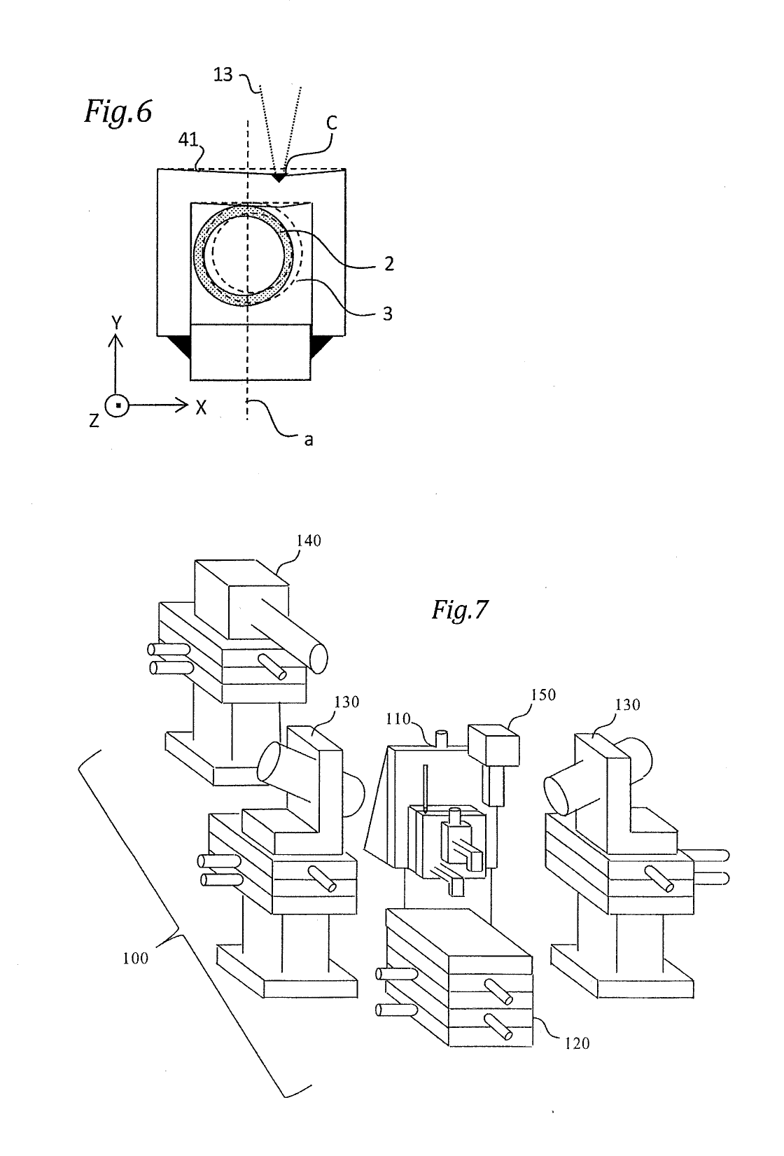

When the position of the collimating lens 2 is to be corrected in X direction or horizontal direction, a position denoted by C (shown in FIG. 6) of the horizontal member 41 of the lens holder 4 is irradiated with the YAG laser light 13. In this process, offsetting C position irradiated with the YAG laser light in +X direction from axis a, which is the central axis of the collimating lens 2, allows the position of the collimating lens 2 to be corrected in −X direction. In a similar manner, offsetting C position in −X direction from the central axis of the collimating lens 2 allows the position of the collimating lens 2 to be corrected in +X direction.

As described, the lens holder 4 and the holder base 5 have the positions different from each other irradiated with the YAG laser light 13, which enables the position of the collimating lens 2 to be corrected in ±X and ±Y directions. Further, changing a irradiation dose for the YAG laser light 13 enables to adjust an extent to which the position of the collimating lens 2 is corrected with sub micrometer order.

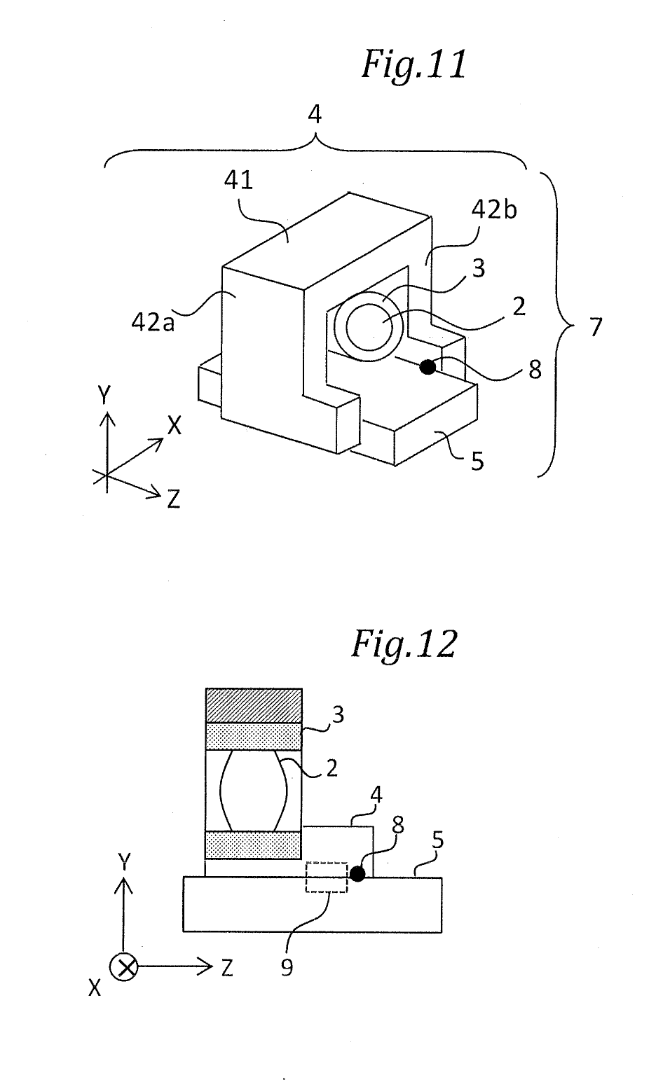

FIG. 11 shows a perspective view of the lens holder 4 according to this embodiment. In a manner similar to First Embodiment, the collimating lens 2 is made of an infrared transparent material such as glass or silicon and it is housed in the lens cylinder 3. The lens cylinder 3 is held by the lens holder 4. Alternatively, the collimating lens 2 may be directly held by the lens holder 4 without the lens cylinder 3 provided therebetween. The lens cylinder 3, which is made of metal, is fixed to the lens holder 4. In this embodiment, the lens holder 4 has an L-shape when seen from X direction and is welded via the YAG laser to the holder base 5 at one or more welding points 8. The welding points 8 include at least two points which are simultaneously formed via the YAG laser welding, the two points being positioned symmetrically with respect to YZ plane including the central axis of the collimating lens 2 therein.

When the collimating lens 2 is to be corrected in −Y direction or downward in a vertical direction, the YAG laser light may be radiated for the adjustment to a region between each of the opposite two welding positions 8 to which the holder and the base member are fixed and the collimating lens 2, the region being contacted to the lens holder 4 and the holder base 5 as shown in FIG. 11.

FIG. 12 shows a sectional view taken along YZ plane including the central axis of the collimating lens 2 therein. The area depicted by broken line in FIG. 12 is an area irradiated with laser light as described above. The position of the collimating lens 2 may be corrected in −Y direction by simultaneous laser irradiation against two points included in the area and positioned symmetrically with respect to YZ plane including the central axis of the collimating lens 2 therein, as in the case where the lens holder 4 and the holder base 5 are fixed to each other via the YAG laser welding. According to this embodiment, the YAG laser light may be radiated from a certain direction (+Y direction) for correcting the position of the collimating lens 2, and further for fixing the lens holder 4 and the holder base 5 to each other and fixing the holder base 5 and the carrier substrate 6 to each other. This allows a rotator provided in the laser head aligning unit 130 of an optical axis alignment apparatus shown in FIG. 7 to be removed, thereby simplifying the apparatus.

### (Optical Axis Alignment Assembling Apparatus)

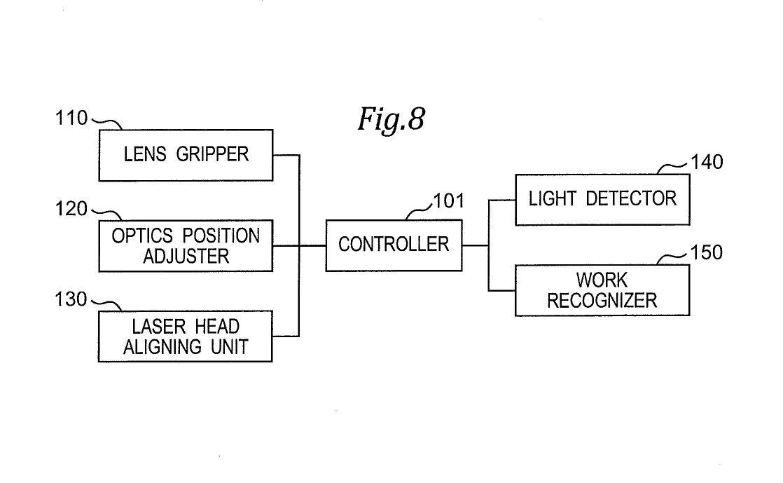

FIG. 7 shows a diagram of an optical axis alignment apparatus according to an embodiment of the present invention and FIG. 8 shows a block diagram illustrating an electrical configuration of the optical axis alignment apparatus. An optical axis alignment apparatus 100 may include a lens gripper 110, optics position adjuster 120, a YAG laser head aligning unit 130, a light detector 140, a workpiece recognizer 150 and a controller 101 for totally controlling the operation of the apparatus.

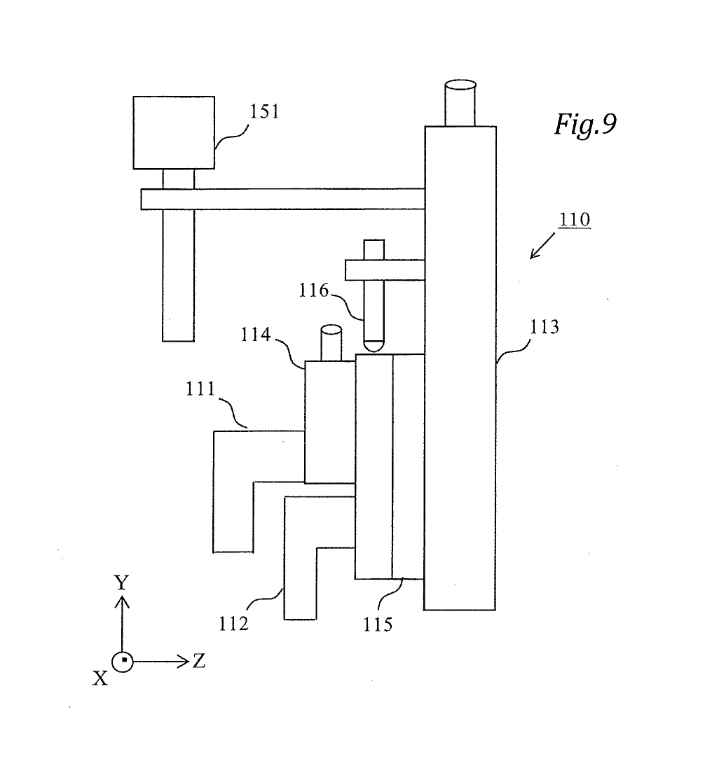

FIG. 9 shows the lens gripper 110. The lens gripper 110 may include a holder gripper 111 for gripping the lens holder 4, a base gripper 112 for gripping the holder base 5, a Y-axis stage 113 on which the holder gripper 111 and the base gripper 112 are mounted and which is activated by a motor, and a Y-axis substage 114 which is operable to adjust a position of the holder gripper 111 in Y direction with respect to the base gripper 112. The Y-axis stage 113 is movable in Y-axis direction, which is perpendicular to the main surface of the carrier substrate 6. Further, the holder gripper 111 and the base gripper 112 are fixed on the Y-axis stage 113 via a slide system 115. The Y-axis substage 114 is mounted on the slide system 115.

The assembling process above includes allowing the Y-axis stage 113 to move in Y-axis direction when the holder base 5 is fixed to the carrier substrate 6 so that the holder base 5 is pushed against the carrier substrate 6. Hence, the lens gripper 110 preferably includes a tactile sensor 16 for detecting when the holder base 5 contacts with the carrier substrate 6. When the holder base 5 contacts with the carrier substrate 6, the slide system 115 displaces in a direction opposite to that of the stage movement. The tactile sensor 116 is configured to detect the displacement. The tactile sensor 116 may include, but not limited to a contact displacement sensor for measuring the displacement.

Referring back to FIG. 7, the optics position adjuster 129 may include an optics attachment cassette and optics alignment stage, the optics attachment cassette being configured to hold the carrier substrate 6 on which the laser light sources 1 are mounted. The optics attachment cassette includes a unit for gripping the carrier substrate (not shown) and a power feeder (not shown) for feeding power to the laser light source 1 (not shown). The optics alignment stage is translatable in X-axis and Y-axis directions and rotatable around X, Y and Z axes, the rotations being defined by the three axes, Sx, Sy and Sz, respectively. That is, the stage is movable in five axes directions. The optics position adjuster 120 may include a unit for gripping the optical multiplexer 10 and a unit for adjusting a gripping position for the optical multiplexer 10. When a gripping position adjusting unit for the optical multiplexer 10 is provided, any number of axes may be target for the optical axis alignment.

The YAG laser head aligning unit 130 is positioned on a stage which allows the position of the YAG laser head to be adjustable in one or more directions, preferably X, Y and Z directions. A plurality of the YAG laser heads are symmetrically positioned with respect to the lens gripper 110.

The light detector 140 may include light receiving elements each having a high sensitivity to light emitted from the laser light source (e.g. infrared light) and being arranged in two dimensions. The light detector 140 may further include an imaging lens focusing the collimated light rays 11 formed by the collimating lens 2 on a light receiving surface of the light receiving element, an translation stage for adjusting a location of the light receiving element and the imaging lens in X, Y and Z directions, and a rotation stage for adjusting an orientation around X, Y and Z directions. The imaging lens has a focal length of infinity in an incident side with respect to the imaging lens where the collimated light ray 11 is incident, so that orientations of the collimated light rays 11 are detectable.

The workpiece recognizer 150, which is positioned on the Y-axis stage 113 of the lens gripper 110, includes a camera 151 for taking an image of the lens holder 4 and the holder base 5 as a workpiece from the upper side. The image taken by the camera 151 is transmitted to the controller 101 of the optical axis alignment apparatus 100 and processed so that a position to which the workpiece is fixed is determined. Preliminarily obtained is a first relation between the workpiece position and the YAG laser irradiation position and a second relation among the YAG laser irradiation condition (an irradiation dose and a YAG laser irradiation position), the extent to which the workpiece should be corrected and the direction in which the workpiece should be corrected. These relations are stored in a database accommodated in the controller 101. The transmission of the image to the controller 101 as well as the calculation of the workpiece position may be a dedicated image processor and the calculated workpiece position may be only transmitted to the controller 101.

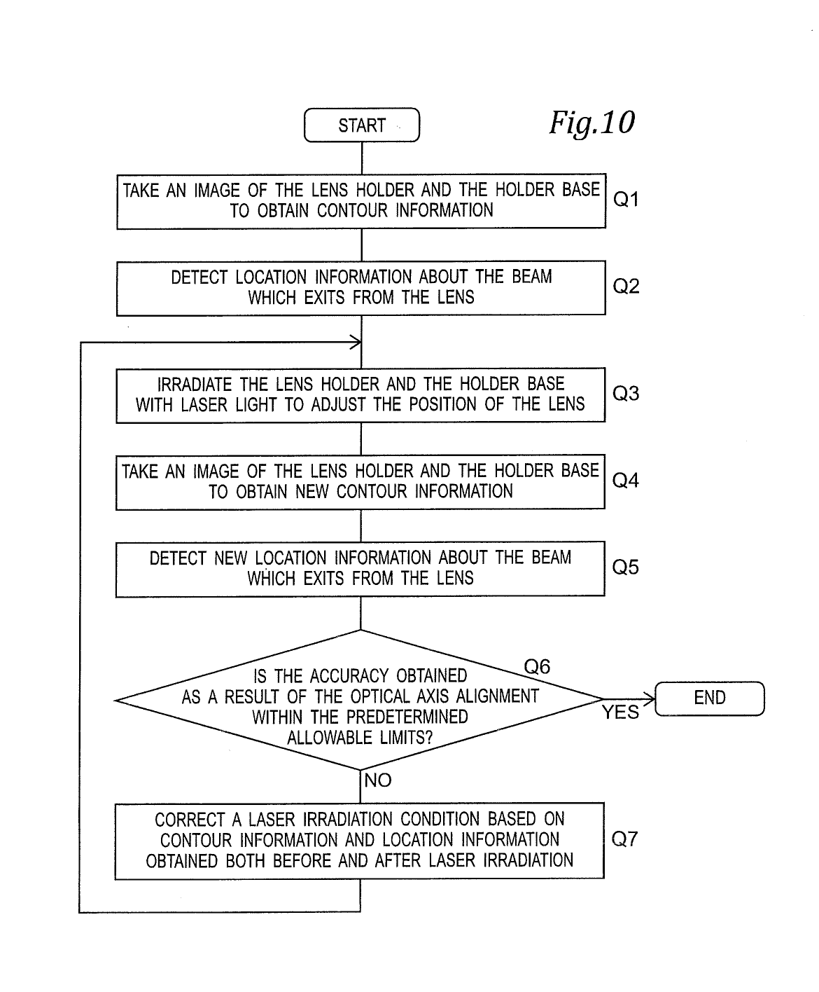

FIG. 10 shows an example of an optical axis alignment method according to an embodiment of the present invention. First, in step Q1, the camera 151 is used to take an image of the lens holder 4 and the holder base 5 to obtain contour information (e.g. a contour and/or a slope of a surface) before the step of laser irradiation and to store it in a database. In step Q2, the laser light source 1 of the light communication module is activated to allow a light beam to be incident on the collimating lens 2 and then the light detector 140 is used to detect location information (e.g. light intensity distribution, maximum intensity point) of a light path of the light beam which exits from the collimating lens 2 and the detected location information is stored in a database.

In step Q3, the controller 101 operates so that at least one of the holder and the base member is irradiated with laser light to plastically deform them depending on a particular laser irradiation condition (e.g. an irradiation position and an irradiation dose), which enables a position of the collimating lens 2 to be adjusted within XY surface perpendicular to the optical axis. The position of the lens is adjusted to correct an irradiation position or an irradiation dose for a subsequent laser irradiation. In Step Q4, the camera 151 is used to take an image of the lens holder 4 and the holder base 5 to obtain new contour information after the laser irradiation and the obtained information is stored in a database. Then, in step Q5, the light detector 140 is used to detect new location information about the light path of the light beam which exits from the collimating lens 2 and then the new information is saved in a database.

Then, in step Q6, whether the accuracy, which is obtained as a result of the optical axis alignment for the collimating lens 2, is within predetermined allowable limits is determined by the controller 101 based on the detected light beam location information. If the accuracy is within the predetermined allowable limits, the optical axis alignment step is finished. Otherwise, following step Q7 is performed. The lens position is adjusted based on the contour information and the location information about the light path which are obtained in steps Q1 and Q2.

In step Q7, the laser irradiation condition (e.g. an irradiation position or an irradiation dose) for the lens position adjustment is now corrected by the controller 101 based on the contour information and/or the location information obtained both before and after the laser irradiation and then the corrected condition is stored in a database. Moving back to Q3, the optical axis alignment is performed again. As such, the optical axis alignment may be performed for the collimating lens 2 for each assembling or manufacturing of the light communication module.

As described above, detecting the collimated light rays 11, which are generated by the laser light sources 1 and the collimating lens 2, by means of the imaging lens having a focal length of infinity enables to measure an extent and a direction of misalignment of the collimated light rays 11, without the external force to be applied against the collimating lens 2 as taught in Patent Document 2 (H2-308209 A), which subsequently allows a direction in which the collimating lens 2 should be corrected to be easily determined.

Further, taking an image of the position, to which the workpiece is fixed, by means of the camera 151 of the workpiece recognizer 150 in order to automatically determine the YAG laser irradiation condition, based on the predetermined relation between the condition and the extent and the direction for the correction for the workpiece, enables to easily align the optical axis of the collimating lens 2.

The present invention is industrially useful in that it allows an optical axis alignment to be performed with a high accuracy and less time required for the alignment.

### DESCRIPTION OF REFERENCE SYMBOLS

1 laser light source
2 collimating lens
3 lens cylinder
4 lens holder
5 holder base
6 carrier substrate
7 lens unit
8 welding position
9 laser irradiation region
10 optical multiplexer
11 collimated light
12 condensing lens
13 YAG laser light
41 horizontal member
42a, 42b vertical member
100 optical axis alignment apparatus
101 controller
110 lens gripper
111 holder gripper
112 base gripper
113 Y-axis stage
114 Y-axis substage
115 slide system
116 tactile sensor
120 optics position adjuster
130 YAG laser head aligning unit
140 light detector
150 work piece recognizer
151 camera

1. An optical axis alignment method for an optical device, the device including a lens having an optical axis, a holder for holding the lens and a base member to which the holder is fixed, the method comprising the steps of:
detecting a first location information about a light path of a light beam which exits from the lens;
taking an image of a contour of the holder and the base member to obtain a first contour information;
by irradiating with laser light at least one of the holder and the base member based on the first location information and the first contour information to plastically deform them, thereby adjusting a position of the lens within a surface perpendicular to the optical axis to correct an irradiation position or an irradiation dose for a subsequent laser irradiation.

2. The method of claim 1, further comprising:
detecting a second location information about a light path of a light beam which exits from the lens after adjusting a position of the lens;
taking an image of a contour of the holder and the base member after adjusting a position of the lens to obtain a second contour information;
correcting an irradiation position or an irradiation dose for a subsequent laser irradiation based on the first location information, the second location information, the first contour information and the second contour information.

3. The method of claim 1, wherein the step of correcting an irradiation position or an irradiation dose includes:
irradiating with laser light an upper surface of the holder holding the lens, when the lens is to be adjusted in a horizontal direction,
irradiating with laser light a position within an upper surface of the holder and on the central axis of the lens, when the lens is to be adjusted downward in a vertical direction, or
irradiating with laser light an upper surface of the base member to which the holder is fixed, when the lens is to be adjusted upward in a vertical direction.

4. The method of claim 3, wherein the step of correcting an irradiation position or an irradiation dose includes irradiating with laser light a position between each of opposite two fixing points where the holder and the base member are fixed to each other and the lens, when the lens is to be adjusted downward in the vertical direction.

5. The method of claim 1, wherein the optical device is a light communication module, the module including:
one or more light sources;
a collimating lens provided as said lens for establishing an optical coupling with the light source;
an optical multiplexer for establishing an optical coupling with the collimating lens;
a substrate on which the light source, the base member and the optical multiplexer are mounted.

6. An optical axis alignment apparatus for an optical device, the device including a lens having an optical axis, a holder for holding the lens and a base member to which the holder is fixed, the apparatus comprising:
a detector for detecting location information about a light path of a light beam which exits from the lens;
a laser irradiator for irradiating with laser light at least one of the holder and the base member to plastically deform them,
a controller for controlling an irradiation position or an irradiation dose for the laser light based on the location information detected by the detector.
an imager for taking an image of a contour of the holder and the base member to obtain contour information, wherein the controller is configured to correct an irradiation position or an irradiation dose for the laser light based on the contour information obtained by the imager.

7. The apparatus of claim 6, wherein the detector includes a light receiving element and an imaging lens for condensing the light beam which exits from the lens into a receiving surface of the receiving element, the imaging lens having a length of infinity in a light incident side.

8. A method for manufacturing an optical device, the method comprising the steps of:
preparing a lens having an optical axis;
preparing a holder for holding the lens;
preparing a base member to which the holder is fixed;
assembling the lens, the holder and the base member;
detecting a first location information about a light path of a light beam which exits from the lens;
taking an image of a contour of the holder and the base member to obtain a first contour information;
by irradiating with laser light at least one of the holder and the base member based on the first location information and the first contour information to plastically deform them, thereby adjusting a position of the lens within a surface perpendicular to the optical axis to correct an irradiation position or an irradiation dose for a subsequent laser irradiation.
